(19) United States
(12) Patent Application Publication
(10) Pub. No.: US 2009/0134196 A1
(43) Pub. Date: May 28, 2009

(54) Pneumatic tool for use in cold environments

(76) Inventor: Nikolai Mulushoff, Hamilton, MT (US)

Correspondence Address: Friederichs Law Firm PLC, 6421 Kurtz Lane, Eden Prairie, MN, 55346-1609, US

(21) Appl. No.: 11/986,700

(22) Filed: Nov. 26, 2007

(51) Int. Cl. B25C 1/04; H05B 3/58

(52) U.S. Cl. 227/130; 392/472

(57) ABSTRACT

Disclosed is a pneumatic tool for use in extreme cold without the risk of freezing of the pressure providing the air: air tubing has electrical heating coils embedded in the walls of the tubing, the connectors between the sections of the hoses.

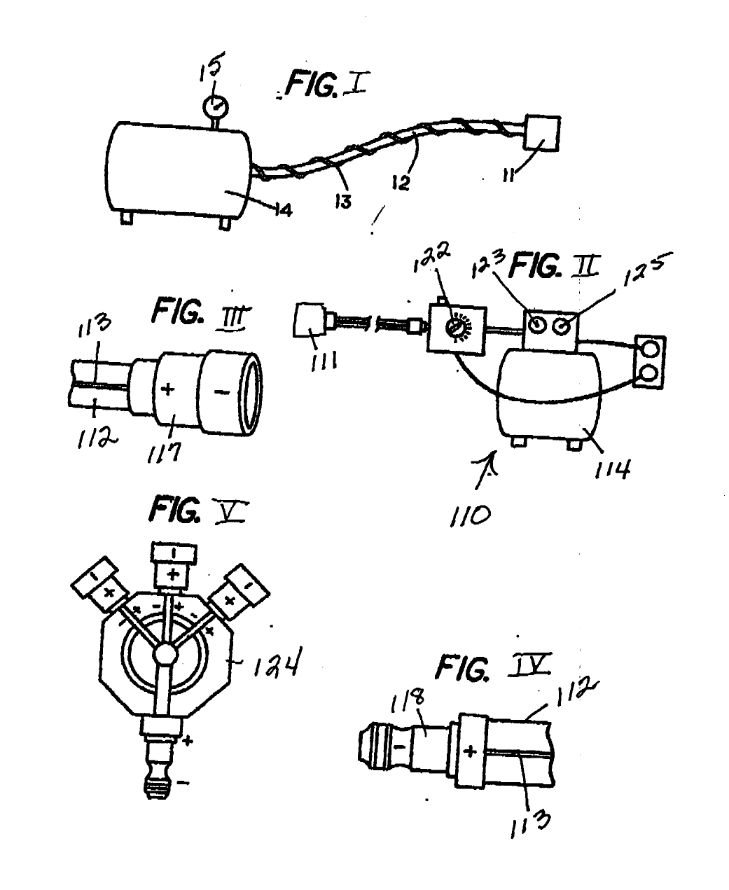

### FIELD OF THE INVENTION

The invention in the field of power tools, such as pneumatic nailers, saws, and drills.

### BACKGROUND OF THE INVENTION

pneumatic tools are known; however, such tools do not disclose a pressured air supply hose having an electrical heating wire imbedded in the wall of the hose.

U.S. Pat. No. 4,197,974 (MORTON et. al.) Shows a conventional NAILER. This patent does not disclose a pressured air supply hose having an electrical heating wire imbedded in the wall of the hose.

U.S. Pat. No. 4,834,131 (AUSTIN) Shows a SAFETY SYSTEM FOR PNEUMATIC TOOLS. The safety system provides an escape valve for relieving excessive air pressure. This patent does not disclose a pressured air supply hose having an electrical heating wire imbedded in the wall of the hose.

U.S. Pat. No. 5,040,563 (WOOD) Shows an ADJUSTABLE AIR PRESSURE VALVE. This patent does not disclose a pressured air supply hose having an electrical heating wire imbedded in the wall of the hose.

U.S. Pat. No. 5,197,257 (NIETLING) Shows an APPARATUS FOR APPLYING SHINGLES TO A ROOF. The apparatus includes a nailing gun, however, the gun does not disclose a pressured air supply hose having an electrical heating wire imbedded in the wall of the hose.

U.S. Pat. No. 5,547,325 (TUCKER et al) Shows NAIL PACKS MADE OF COMPOSITES HAVING HIGH COMPRESSIVE STRENGTH AND FLEXURAL MODULES. The apparatus includes a nailing gun, however, the gun does not include does not disclose a pressured air supply hose having an electrical heating wire imbedded in the wall of the hose.

U.S. Pat. No. 6,834,789 (DION) Shows a PNEUMATIC FASTENER DRIVING TOOL FOR HARDWOOD FLOORING. The apparatus includes a nailing gun, however, the gun does not disclose a pressured air supply hose having an electrical heating wire imbedded in the wall of the hose.

U.S. Pat. No. 6,932,128 (TURAN) Shows APPARATUS AND METHOD FOR USING A LIGHTWEIGHT PORTABLE AIR/GAS POWER SUPPLY. The patent shows a tank that is carried on one's back connected by a hose to a gun carried by one's hand. The hose does not include an electrical heating wire imbedded in the wall of the hose.

U.S. Pat. No. 7,153,106 (CORWELL) Shows a AIR COMPRESSOR UNIT INLET CONTROL. The apparatus includes a nailing gun, however, the gun does not disclose a pressured air supply hose having an electrical heating wire imbedded in the wall of the hose.

The following patents, U.S. Pat. Nos. 3,251,480; 3,646,498; 3,773,186; 3,812,444; 5,586,668 show that it is standard with brakes such as on a train to have a combined electrical and air pressure connector. However, this does not teach the nailing gun with a pressured air supply hose having an electrical heating wire imbedded in the wall of the hose.

### SUMMARY OF THE INVENTION

The present invention is a pneumatic tool system for use in extreme cold without the risk of freezing of the tube providing the pressurized air. The tool system includes a pneumatic tool connected to a source of pressure air by air tubing mat has electrical heating coils embedded in the walls of the tubing. The connectors between the sections of the hoses provides electrical connection. The tool may be a nailer, saw, drill or any other of the numerous conventional pneumatic tools.

### IN THE DRAWING

FIG. I is a schematic plan view of the present invention;

FIG. II is a schematic plan view of another embodiment of the present invention;

FIG. III is a perspective view of the first female end of the hose portion of the present invention;

FIG. IV is a perspective view of the male end of the hose portion of the present invention;

FIG. V is a plan view an alternative portion of the present invention;

### DETAILED DESCRIPTION OF THE PRESENT INVENTION

A pneumatic tool system 10 (FIG. I) for use in extreme cold without the risk of freezing of the tube mechanism 12 providing the pressurized air. The tool system 10 has a pneumatic tool 11, such as a nailer, a saw, a drill or a similar conventional gas driven tool. Tubular mechanism 12 connected to feed pressurized gas to said tool 11. Pressure source of gas, such as a conventional compressor or compressed gas tank 14. The pneumatic tool system 10 of wherein said tubular mechanism for applying heat electrical heating coil 13, comprises tubing 12 said electrical heating coil means embedded in the walls of said tubing. The tubing 12 may have a plurality of discrete sections of tubing to permit elongation of the tubing. The plurality of discrete sections of tubing has connectors disposed between said sections of the hoses provides electrical connection. The compressed gas tank 14 may have a gauge 15 to show how much gas remains in the tank 14. The compressed gas may be compressed air.

An alternative preferred embodiment, pneumatic tool system 110, is shown in FIGS. II through V. The tool system 110 has a pneumatic tool 111, such as a nailer, a saw, a drill or a similar conventional gas driven tool. Tubular mechanism 112 connected to feed pressurized gas to said tool 111. Pressured source of gas, such as a conventional compressor or compressed gas tank 114. The pneumatic tool system 110 of wherein said tubular mechanism 112 for applying heat electrical heating coil 113, comprises tubular mechanism 112 said electrical heating mechanism embedded in the walls of said tubing 112. The tubing 112 may have a plurality of discrete sections of tubing 112 to permit elongation of the tubing. The plurality of discrete sections of tubing 112 has connectors disposed between said sections of the hoses provides electrical connection.

The conventional compressor or compressed gas tank 114 (FIG. II) may be connected to an electrical power source by an electrical cord 116. The female end portion 117 is disposed at one end of the tubing 112 and the male end portion 118 is disposed at the opposite end of the tubing 112. The end portions 117 and 118 are adapted to feed the electricity and the gas, such as air, there through. The pneumatic tool system 110 may be equipped with a pressure measuring gauge 125 to tell what pressure remains in the tank 114. The pneumatic tool system 110 may be equipped a temperature gauge switch 122. The pneumatic tool system 110 may be equipped a valve 123 for turning off the supply of air pressure when the tool 111 is not in use. The pneumatic tool system 110 may be equipped with a multi headed connector 124 for supplying a plurality of tools. For example, when are more than one workman using the same tank 114.

What is claimed is:

1) A pneumatic tool system for use in extreme cold without the risk of freezing of the tube providing the pressurized air, the tool system comprising:
pneumatic tool;
tubular means connected to feed pressurized gas to said tool;
source means for pressurized gas;
heating means for applying heat to said tubular means.

2) The pneumatic tool system of claim 1 wherein said means for applying heat comprises electrical heating coil means.

3) The pneumatic tool system of claim 2 wherein said tubular means comprises tubing.

4) The pneumatic tool system of claim 3 wherein said means for applying heat comprises said electrical heating coil means embedded in the walls of said tubing.

5) The pneumatic tool system of claim 4 wherein said tubular means comprises plurality of discrete sections of tubing.

6) The pneumatic tool system of claim 5 wherein said plurality of discrete sections of tubing has connectors disposed between said sections of the hoses provides electrical connection.

7) A pneumatic nailer for use in extreme cold without the risk of freezing of the pressurized air comprising: a source of pressurized air; a pneumatic nailer and tubing interconnecting said source and said nailer, said air tubing having electrical heating coils embedded in the walls of the tubing.

8) A pneumatic nailer system for use in extreme cold without the risk of freezing of the tube providing the pressurized air, the nailer system comprising:
pneumatic nailer;
tubular means connected to feed pressurized gas to said nailer;
source means for pressurized gas;
heating means for applying heat to said tubular means.

9) The pneumatic nailer system of claim 8 wherein said means for applying heat comprises electrical heating coil means.

10) The pneumatic nailer system of claim 9 wherein said tubular means comprises tubing.

11) The pneumatic nailer system of claim 10 wherein said means for applying heat comprises said electrical heating coil means embedded in the walls of said tubing.

12) The pneumatic nailer system of claim 11 wherein said tubular means comprises plurality of discrete sections of tubing.

13) The pneumatic nailer system of claim 12 wherein said plurality of discrete sections of tubing has connectors disposed between said sections of the hoses provides electrical connection.
